(19) United States
(12) Patent Application Publication
(10) Pub. No.: US 2010/0321532 A1
(43) Pub. Date: Dec. 23, 2010

(54) SOLID-STATE IMAGING DEVICE, IMAGING SYSTEM, AND METHOD OF DRIVING SOLID-STATE IMAGING DEVICE

(75) Inventors: Seiji Hashimoto, Yokohama-shi (JP); Keisuke Ota, Tokyo (JP); Kazuyuki Shigeta, Yokohama-shi (JP); Takeru Ohya, Machida-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/526,427

(22) PCT Filed: Oct. 29, 2008
(86) PCT No.: PCT/JP2008/070152

§ 371 Date: Aug. 7, 2009

(30) Foreign Application Priority Data
Nov. 8, 2007 (JP) 2007-290733

(51) Int. Cl. H04N 9/68; H04N 5/335

(52) U.S. Cl. 348/234; 348/300; 348/E05.091; 348/E09.053

(57) ABSTRACT

The invention provides a solid state imaging device and imaging system, both capable of obtaining a good image suppressing the reduction of the SN ratio thereof, suppressing the increase of the chip size of the imaging device and suppressing the increase of power consumption of a sensor without performing complicated processing even if there are regions different in luminance mutually in an imaging plane. Variable gain units provided correspondingly to columns of pixels amplify the signals from the pixels by different gains group by group of the pixels each group including a plurality of pixels according to the signals from the outside.

### TECHNICAL FILED

The present invention relates to solid-state imaging device and an imaging system using the solid-state imaging device, and more particularly to a solid-state imaging device controlling the brightness of an image in a imaging plane.

### BACKGROUND ART

When an object is imaged, there may be a light region and a dark region in an imaging plane according to the condition of a light source to the object. As a technique of performing the exposure control of an imaging device under such an imaging condition, the techniques disclosed in Japanese Patent Application Laid-Open No. 2004-15701 and Japanese Patent Application Laid-Open No. 2001-145005 exist.

The solid-state imaging device disclosed in the Japanese Patent Application Laid-Open No. 2004-15701 provides the function of detecting the magnitude of each pixel signal individually to set a gain to the magnitude of the signal individually to the column region portion of a sensor.

Moreover, the Japanese Patent Application Laid-Open No. 2001-145005 discloses the switching of read modes between a skip mode of reading pixels at a predetermined thinning out ratio and a block mode of reading pixels in a certain region without thinning out the pixels, and the adjusting of gains with a processing unit outside sensors when the numbers of reading pixels are mutually different between both the modes.

Moreover, Japanese Patent Application Laid-Open No. H09-214836 discloses the outputting of the images read in a skip mode and the images read in a block mode alternately every frame.

In the case of imaging using an imaging device, luminance is generally not uniform in an imaging plane, and there are a high luminance region and a low luminance region. But luminance is frequently substantially the same luminance within each region. If the gain of each pixel is severally adjusted like the technique disclosed in the Japanese Patent Application Laid-Open No. 2004-015701 in such a case, then the processing becomes complicated and power consumption also increases. Thus, the technique is not preferable. Moreover, if the circuits performing signal processing are provided in the imaging device like the technique disclosed in the Japanese Patent Application Laid-Open No. 2004-015701, then the increase of a chip size is caused, and it is apprehended that the requirement of miniaturization is not satisfied.

Moreover, if gain adjustment is performed on the outside of the sensors like the technique disclosed in the Japanese Patent Application Laid-Open No. H09-214836, the possibility of superimposing noises on the path to the gain adjusting section increases, and it is apprehended that the SN ratios of signals decrease.

The Japanese Patent Application Laid-Open No. 2001-145005 does not disclose the gain adjustment, and it is conceivable that, if there is a region having the luminance remarkably different from that in the other regions in an imaging plane, then the image obtained from the signals in the region is saturated to be white or to be remarkably dark. Thus, the technique cannot obtain a good image.

### DISCLOSURE OF THE INVENTION

It is an object of the present invention to provide a solid-state imaging device, an imaging system, and a method of driving a solid-state imaging device, all capable of obtaining a good image suppressing the degradation of the SN ratio thereof while suppressing the increase of the chip size of the imaging device and suppressing the increase of power consumption of sensors without performing complicated processing even if there are regions different in luminance mutually in an imaging plane.

According to an aspect of the present invention, a solid-state imaging device comprises: a pixel portion including pixels arranged along rows and columns; and a plurality of variable gain units corresponding to the columns of the pixel portion, wherein the variable gain units amplify signals from first and second pixel groups each including the plurality of pixels of the pixel portion, in different gains for each of the groups of the pixels, responsive to a gain control signal input from an external.

Moreover, according to another aspect of the present invention, an imaging system comprises: the solid-state imaging device further including an output unit for externally outputting the first pixel groups correspond to whole of the pixel portion, and signal outputting pixels among the pixels included in the first pixel groups are arranged in a first density, a signal amplified by the variable gain unit; and a control unit for supplying the gain control signal to the plurality of variable gain units.

Moreover, according to a further other aspect of the present invention, a method of driving a solid-state imaging device comprises: a pixel portion including pixels arranged along rows and columns; and a plurality of variable gain units corresponding to the columns of the pixel portion, wherein the method comprising a step of controlling the variable gain units to amplify signals from first and second pixel groups each including the plurality of pixels of the pixel portion, in different gains for each of the groups of the pixels.

According to the present invention, even if there are regions having mutually different luminance in an imaging plane, a good image suppressing the reduction of the SN ratio thereof can be obtained while suppressing the increase of the chip size of an imaging device and suppressing the increase of power consumption of sensors without performing complicated processing.

Further features of the present invention will become apparent from the following description of exemplary embodiments with reference to the attached drawings.

### BRIEF DESCRIPTION OF THE DRAWINGS

FIG. 1 is a schematic view illustrating a solid-state imaging device according to first and second exemplary embodiments of the present invention.

FIG. 2 is a schematic view illustrating an imaging plane according to the first exemplary embodiment of the present invention.

FIGS. 3A, 3B, and 3C are diagrams illustrating drive timing according to the first exemplary embodiment of the present invention.

FIG. 4 is a schematic view illustrating an imaging system according to an exemplary embodiment of the present invention.

FIG. 5 is a schematic view illustrating a circuit performing the determination of brightness according to the first exemplary embodiment of the present invention.

FIG. 6 is a schematic view illustrating an amplifier according to an exemplary embodiment of the present invention.

FIG. 7 is a schematic view illustrating an imaging plane according to the second and third exemplary embodiments of the present invention.

FIG. 8 is a diagram illustrating drive timing according to the second exemplary embodiment of the present invention.

FIG. 9 is a schematic view of a solid-state imaging device according to the third exemplary embodiment of the present invention.

FIG. 10 is an equivalent circuit diagram of a pixel according to the third exemplary embodiment of the present invention.

FIG. 11 is a diagram illustrating drive timing according to the third exemplary embodiment of the present invention.

FIG. 12 is a diagram illustrating the drive timing according to the third exemplary embodiment of the present invention.

FIG. 13 is another equivalent circuit diagram of a pixel according to the third exemplary embodiment of the present invention.

### BEST MODE FOR CARRYING OUT THE INVENTION

### First Exemplary Embodiment

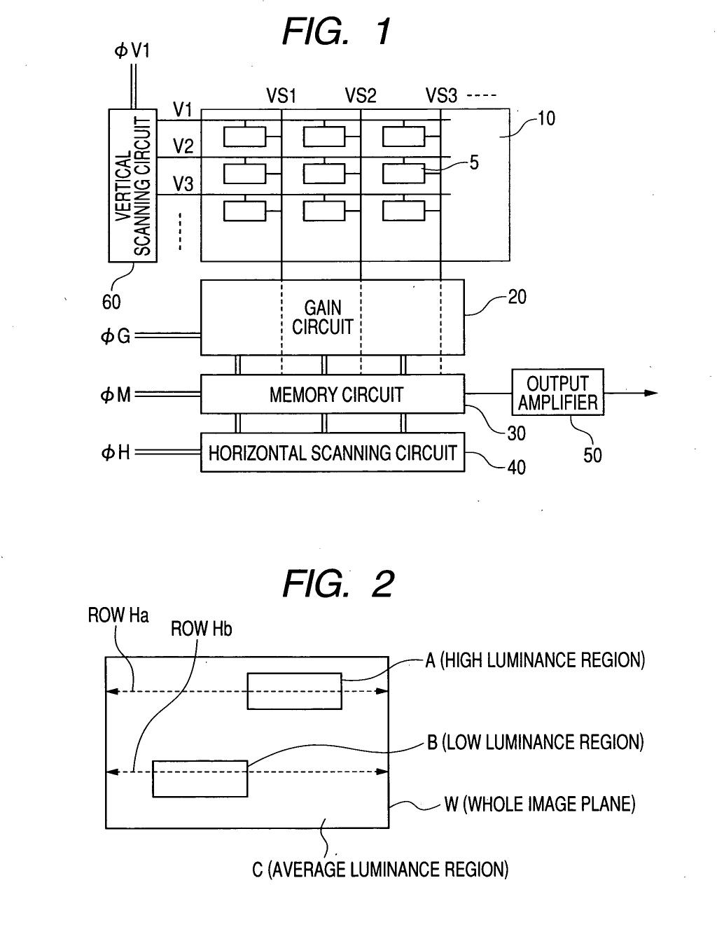

A first exemplary embodiment according to the present invention is described with reference to FIGS. 1 to 4. FIG. 1 is a schematic view illustrating an example of a solid-state imaging device according to the first exemplary embodiment of the present invention. Each configuration in the figure is formed on the same semiconductor substrate.

Pixels 5 are arranged in a matrix in a pixel portion 10 of the solid-state imaging device 100. The pixels 5 in the same row are connected by each of the control lines V1, V2, . . . , Vn in common, and the signals of the pixels 5 in the same row are read to vertical signal lines VS1, VS2, . . . , VSn at the same timing when the pixels 5 receive a signal from a vertical scanning circuit 60. The signals read on the vertical signal lines VS1, VS2, . . . , VSn are input into a gain circuit 20, which is a variable gain unit including variable gain amplifiers provided on each of the vertical signal lines VS1, VS2, . . . , VSn. The gains of the amplifier are set by a signal φG, which is a gain control signal input from the outside. A memory circuit 30 including memories provided correspondingly to the respective amplifiers of the gain circuit 20 temporarily hold the signals amplified by the amplifiers in the gain circuit 20. The memories in the memory circuit 30 are sequentially scanned by a horizontal scanning circuit 40, and the signals stored in the memories are output from the solid-state imaging device 100 through an output amplifier 50, which is an output unit. Signals φV1, φG, φM, and φH in the figure are ones for controlling the driving of the corresponding circuits 60, 20, 30, and 40, respectively. Although some of the signals φV1, φG, φM, and φH actually include a plurality of signals, the signals are severally expressed as one signal for simplification.

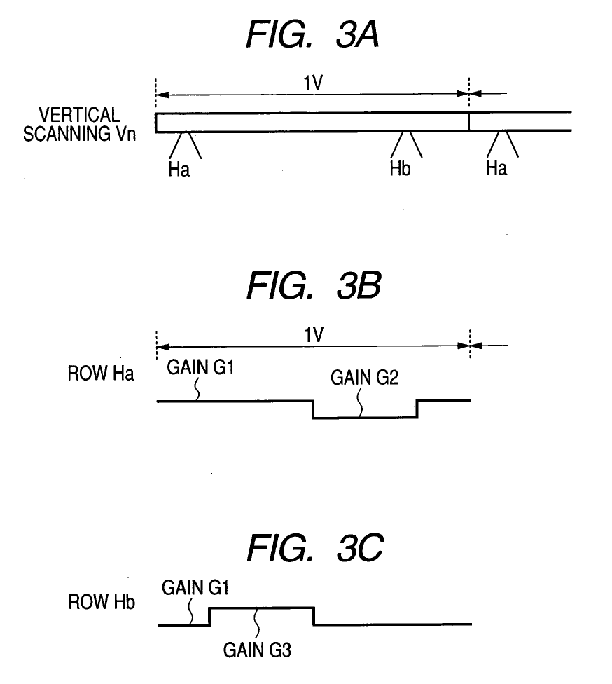

FIG. 2 illustrates a schematic view of an imaging plane corresponding to the pixel portion 10 of the solid-state imaging device 100 in FIG. 1. FIG. 3 is a diagram illustrating the changes of timing and gains at the time of scanning the imaging plane illustrated in FIG. 2.

In FIG. 2, a region W expresses the whole of the imaging plane to be recorded in a recording system & communication system, which will be described later. A region C is one having average luminance as the whole of the region C, and the pixels in the region C are denoted as a first pixel group here. A region A is a high luminance region having higher overall luminance in the region in comparison with the luminance in the region C, and a region B is a low luminance region having lower overall luminance in the region in comparison with the luminance in the region C. The pixels in the regions A and B are denoted as those of a second pixel group here. A row Ha in the figure denotes that of pixels (pixel row) including the high luminance region A, and a row Hb denotes a pixel row including the low luminance region B.

FIG. 3A shows the situation of vertical scanning of an image screen illustrated in FIG. 1. The rows Ha and Hb are scanned during a frame period 1V, during which the pixel rows in the image screen are sequentially scanned from the uppermost row by the row. Letters Ha and Hb in FIG. 3A indicate the horizontal scanning periods of the corresponding rows.

FIG. 3B illustrates the changes of gains in the row Ha including the high luminance region A during one horizontal scanning period (1H). The gains of the corresponding amplifiers during the periods during which the pixels in the region C, the average luminance region, are scanned, that is, corresponding to the columns in which the pixels in the region C exist, are set to a gain G1. On the other hand, the gains of the amplifiers corresponding to the period during which the pixels in the region A, the high luminance region, are scanned, that is, corresponding to the columns on which the pixels in the region A exist, are set to a gain G2 lower than the gain G1. By setting the gains of the amplifiers corresponding to the high luminance region A to be lower than the gains of the amplifiers corresponding to the average luminance region C in this manner, the saturation of a signal by the gain circuit 20 can be reduced.

FIG. 3C illustrates the changes of gains in the row Hb including the low luminance region B during a horizontal scanning time. Similarly to the row Ha, the gains of the corresponding amplifies during the periods during which the pixels in the region C, the average luminance region, are scanned, that is, corresponding to the columns in which the pixels in the region C exist, are set to the gain G1. On the other hand, the gains of the amplifiers corresponding to the period during which the pixels in region B, the low luminance region, are scanned, that is, corresponding to columns on which the pixels in the region B exist, are set to a gain G3 higher than the gain G1. By setting the gains of the amplifiers corresponding to the low luminance region B to be higher than the gains of the amplifiers corresponding to the average luminance region C in this manner, the deterioration of the SN ratio owing to system noises can be reduced.

The determination of the luminance of each of the regions A, B, and C is not performed every pixel here unlike the technique disclosed in the Japanese Patent Application Laid-Open No. 2004-15701, but is determined on the basis of the overall luminance of each of the regions A, B, and C. For example, a pixel α having especially high luminance and pixels β having not so high luminance are generally included in the high luminance region A, and the technique disclosed in the Japanese Patent Application Laid-Open No. 2004-15701 would set the gain of the amplifier to the signal from the pixel a to be low and the gains of the amplifiers to the signals from the pixels β to be high. On the other hand, the present invention uniformly sets the gains to the signals from the pixels in the region A having high average luminance, and consequently no circuits for performing complicated processing are required.

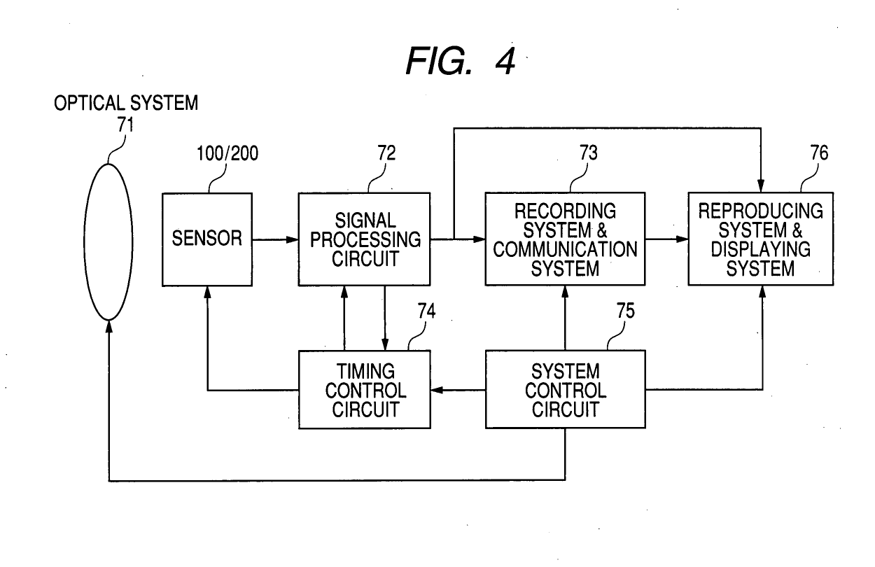

Next, an example of the method of obtaining the average luminance of each of the regions A, B, and C is described. FIG. 4 is a schematic view of an imaging system. In FIG. 4, an optical system 71, such as a lens, forms an image of an object on the pixel portion 10 of the solid-state imaging device 100. Each pixel 5 in the pixel portion 10 performs a photoelectric conversion according to an incident light, and is scanned vertically and horizontally. Then, a signal is output from the solid-state imaging device 100 to be input into a signal processing circuit 72.

The signal processing circuit 72 performs the analogue to digital (AD) conversion of the signal from the solid-state imaging device 100, and the compression of a digital signal obtained by the AD conversion. The signal processing circuit 72 further includes a processing system for operating the average luminance of an arbitrary region in the imaging plane here. The digital signal output from the signal processing circuit 72 is recorded in an internal memory or a removable medium by recording system & communication system 73, which output the digital signal to reproducing system & displaying system 76. The digital signal may be directly output from the signal processing circuit 72 to the reproducing system & displaying system 76, which displays an image according to the received signal.

A timing control circuit 74, which is a control unit, for example, controls the timing of driving the solid-state imaging device 100 according to the information indicating the average luminance of the regions A, B, and C, which average luminance is operated by the signal processing circuit 72, and the timing control circuit 74 inputs a gain control signal into the solid-state imaging device 100 to control the gains of the amplifiers. A system control circuit 75 performs, for example, the control of the circuits constituting the system according to the previously stored programs.

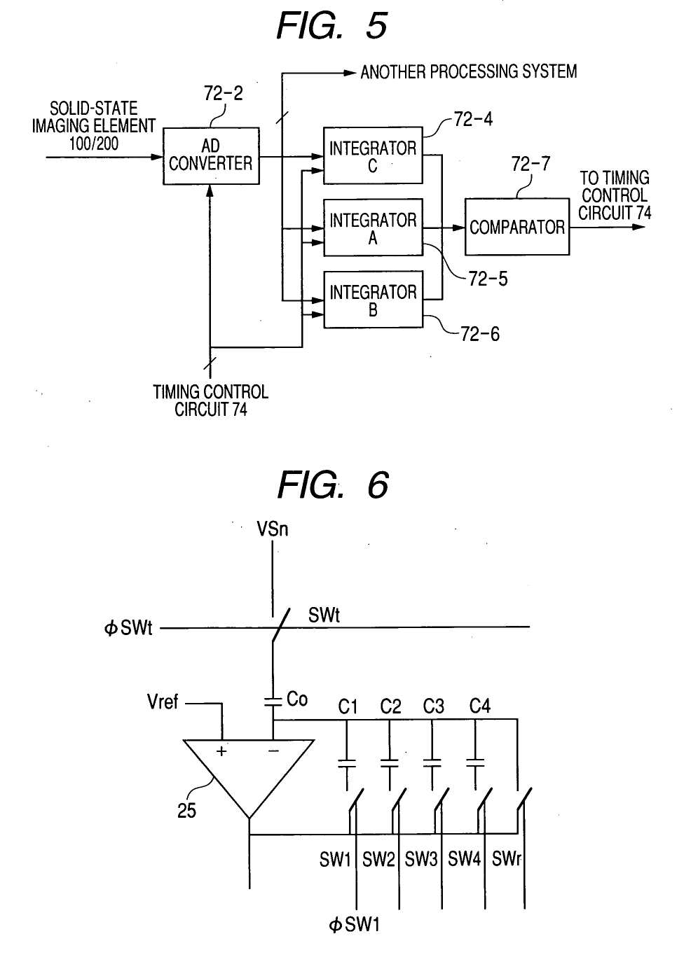

FIG. 5 illustrates the configuration for obtaining the overall luminance of the regions A, B, and C in an imaging plane. The configuration is included in the signal processing circuit 72. A signal output from the solid-state imaging device 100 is input into the signal processing circuit 72, and converted into a digital signal by an AD converter 72-2. The converted digital signal is integrated by integrators 72-4, 72-5, and 72-6 corresponding to each region (watching partial regions 1 and 2, and the region C except for the partial regions 1 and 2 here). The integrated value obtained by each of the integrators 72-4 to 72-6 is compared with one another by a comparator 72-7, and the result of the comparison is output from the comparator 72-7. When the luminance signal of the result of the comparison is input into the timing control circuit 74, the timing control circuit 74 outputs a not-shown gain control signal for setting the gains of the amplifiers so that the images obtained from the watching partial regions 1 and 2 may have the average brightness of the image in the region C except the partial regions 1 and 2, or so that the whole image plane including the partial regions 1 and 2 may have objective brightness. The gain control signal is uniformly set to the amplifiers corresponding to each of the regions A, B, and C. Consequently, the imaging device becomes unnecessary to perform complicated processing to set a gain every pixel, and the imaging device can be realized by a simple configuration. Thus, the present configuration is effective for suppressing the increase of power consumption. Incidentally, the configuration provided with three integrators 72-4, 72-5, and 72-6 are exemplified to be described here, the number of the integrators 72-4, 72-5, and 72-6 may be increased or decreased as the occasion demands.

As described above, according to the present exemplary embodiment, even if the region A or B having higher or lower luminance than the average luminance of the region C exists in the imaging plane, the recognition range of an object image can be widened by lowering or heightening the gains of the amplifiers in the high luminance region A or the low luminance region B, respectively. Furthermore, according to the present exemplary embodiment, the luminance is not determined every pixel, but the gains of the amplifiers are set in every regions A, B, and C on the basis of the overall luminance of the regions A, B, and C. Consequently, no complicated circuits are needed. Thus, the increase of power consumption and the chip area can be suppressed.

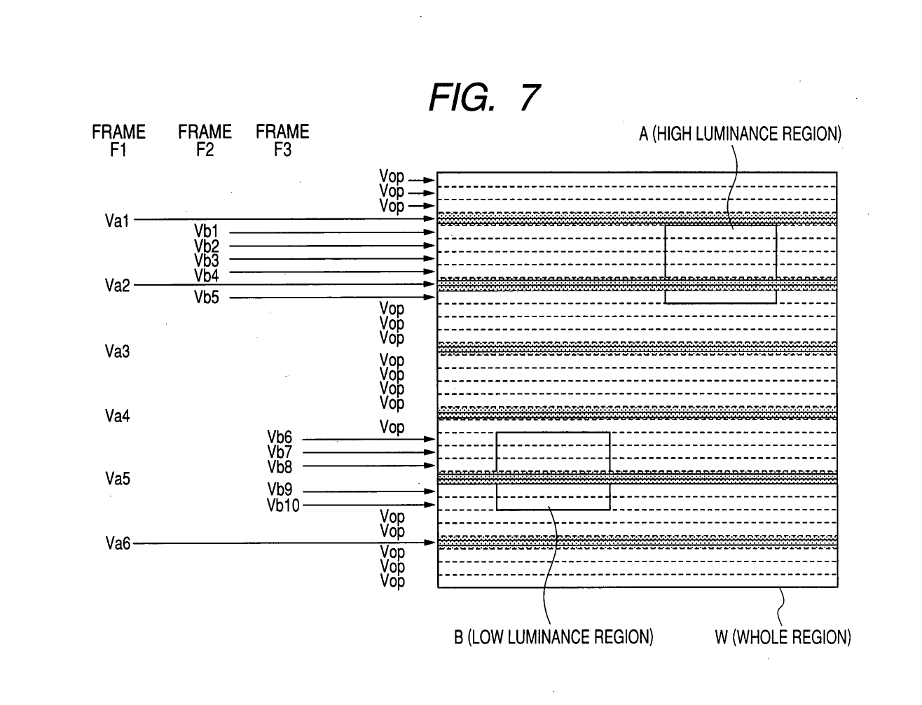

FIG. 6 illustrates a configuration example of an amplifier provided in each column of the gain circuit 20. A switch SWt is for switching the conduction state between a vertical signal line VSn and an amplifier 21, and is connected to the vertical signal line VSn and one terminal of a clamping capacitor C0 of the amplifier 21. The other terminal of the clamping capacitor C0 is connected to the inverting input terminal of an operational amplifier 25. Feedback capacitors C1, C2, C3, and C4 connect the inverting input terminal of the operational amplifier 25 and the output terminal thereof through switches SW1, SW2, SW3, and SW4, respectively. The conduction states of the switches SW1, SW2, SW3, and SW4 are switched by signals φSW1, φSW2, φSW3, and φSW4, respectively, input from the timing control circuit 74. A reset switch SWr is provided between the inverting input terminal of the operational amplifier 25 and the output terminal thereof, the conduction state of which reset switch SWr is switched by a signal φSWr input from the timing control circuit 74. Moreover, a reference voltage Vref is applied to the non-inverting input terminal of the operational amplifier 25.

The gain of the amplifier 21 configured in this manner becomes a value determined by a ratio of the capacitance of the connected feedback capacitor (one of the capacitors C1-C4) and that of the clamping capacitor C0. The timing control circuit 74 sets the gain of the amplifier 21 by selectively inputting the signals φSW1, φSW2, φSW3, and φSW4 in order to set a gain according to the average luminance of one of the regions A, B, and C. The feedback capacitor connected to the feedback path is not limited to one at a time, but a plurality of feedback capacitors may be connected at the same time. The capacitance values of the feedback capacitors C1-C4 may be the same or be mutually different. Moreover, the example of providing the one clamping capacitor C0 and the four feedback capacitors C1-C4 is illustrated here, the number of the capacitors is not limited to the above ones.

According to the present exemplary embodiment, the gain circuit 20 amplifies the signals from the pixels in the region C and in the regions A and B, that is, from the pixels in the first and second pixel groups, respectively, according to the gain control signal φG input from the outside in a different gain for every group of the pixels. Thereby, a good image, suppressing the degradation of the SN ratio thereof can be obtained while suppressing the increase of the chip size of the imaging device and suppressing the increase of power consumption of a sensor without performing complicated processing even if there are the regions A, B, and C having different luminance from one another in the imaging plane.

### Second Exemplary Embodiment

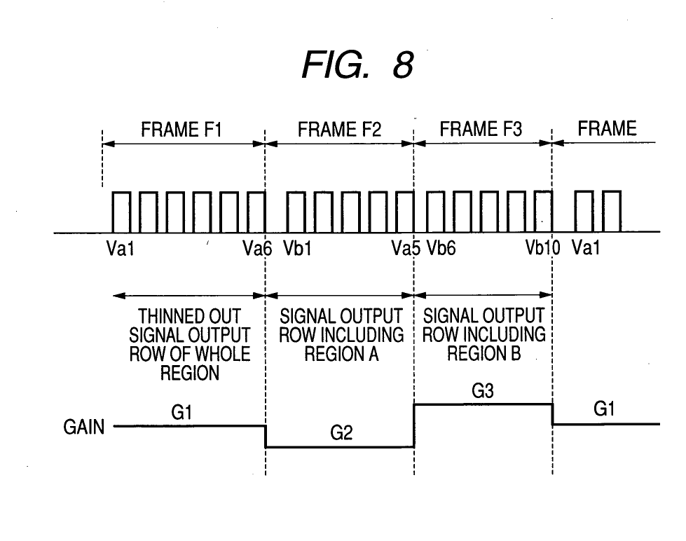

A second exemplary embodiment according to the present invention is described with reference to FIGS. 7 and 8. In the first exemplary embodiment, the example of reading all regions A, B, and C in the imaging plane during one frame period has been described. On the other hand, in the present exemplary embodiment, an exemplary embodiment of reading partial regions A and B in different frames from the frame in which the whole region W is read by thinning out the read of the whole region W is described.

FIG. 7 is a diagram illustrating a situation of an imaging plane and the timing of scanning each row in the imaging plane. In FIG. 7, pixel rows Va1, Va2, . . . , Va6, illustrated by being hatched by meshes, are read in a frame F1. Pixel rows Vb1, . . . , Vb5, which are included in the partial region A and are not the pixel rows Van (n: natural numbers), are read in a frame F2. Pixel rows Vb6, . . . , Vb10, which are included in the partial region B and are not the pixel rows Van, are read in a frame F3. The pixels in the pixel rows Va1, . . . , Va6 are expressed as the pixels in the first pixel group, and the pixels in the pixel rows Vb1, . . . , Vb5 and the pixel rows Vb6, . . . , Vb7 are expressed as the pixels in the second pixel group. The pixels in pixel rows Vop output no signals.

By thinning out the read of the image in the whole region W in this manner, an image can be obtained at a higher speed in comparison with the case of reading the signals of all the pixels in the whole region W. As to the partial regions A and B, by limiting the pixel regions A and B from which signals are read, the images in the partial regions A and B can be also obtained at higher speeds.

Furthermore, in the present exemplary embodiment, the signals read from the pixels in the pixel rows that are read in the frame F1 and include either of the partial regions A and B among the signals read from the pixels in the pixel rows Va1, . . . , Va6, which are read in the frame F1, are used only for forming the image of the whole region W, and are not used for forming the images of any of the partial regions A and B. That is, from the pixels in the row Va2, the signals in the pixels are read only in the frame F1 and are not read in the frame F2. The situation is the same as to the pixels in the row Va5. Moreover, the signals from the pixels in the rows other than the pixel rows Va1, Va2, . . . , Va6, illustrated by being hatched by meshes, are not used for forming the image of the whole region W. By changing the gains of the amplifiers every frame in the case of performing such a read, good images can be obtained from the respective regions A, B, and C by simpler control.

FIG. 8 illustrates the schematic timing of horizontal scanning at the time of performing the aforesaid control. In frame F1, the pixel rows of the whole region W are thinned out to be read, and the pixel rows Va1-Va6 are sequentially scanned. In the succeeding frame F2, the pixel rows Vb1-Vb5 including the partial region A are sequentially scanned. In the frame F3, the pixel rows Vb6-Vb10 including the partial region B are sequentially scanned. Frames F1′, F2′, F3′, . . . follow the frame F3. The images of the frames A, B, and C obtained in this manner may be separately displayed on a display apparatus displaying only the image of the whole region W and a display apparatus displaying only the partial regions A and B, or may be displayed in different regions on the same display apparatus.

If it is supposed that the partial region A is a high luminance region and the partial region B is a low luminance region on the basis of the average luminance of the whole region W here, then the gains of the amplifiers change as illustrated in the lowermost line in FIG. 8. If the gains of the amplifiers in the region of the frame F1 is set as a gain G1, then the gains of the amplifiers in the region of the frame F2, during which the pixel rows including the partial region A, the average luminance of which is higher, are scanned, are set to a gain G2 lower than the gain G1, and the gains of the amplifiers in the region of the frame F3, during which the pixel rows including the partial region B, the average luminance of which is lower, are scanned, are set to a gain G3 higher than the gain G1.

The gains of the amplifiers may be set to the same gain in all the rows, or, for example, only the gains of the amplifiers in the partial region A may be set uniformly in the frame F2, and the gains of the amplifiers in the regions other than the partial region A may be set to be different from the gains of the amplifiers in the partial region A. The setting is based on the fact that the signals from the pixels other than those in the pixel rows Va1-Va6, illustrated being hatched by meshes, are not used for forming the image in the whole region W, as described above.

Moreover, the pixel rows Vb1-Vb10 may be scanned at one time, or the pixel rows Vb1-Vb5 and Vb6-Vb10 may be scanned by different scanning, as the scanning for reading the signals of the partial regions A and B. The term of the frame is considered by the image displayed in the reproducing system & displaying system 76 here. Consequently, partial regions A and B are considered as the regions scanned in different frames whether the scanning is performed at a time or at different time.

Moreover, as to the pixel rows Vat and Va6 in the frame F1, for example, the gains of the amplifiers may be mutually different in the columns of the whole region W and the columns of the high luminance region A like the first exemplary embodiment.

According to the present exemplary embodiment, a good image suppressing the degradation of the SN ratio thereof can be obtained, suppressing the increase of the chip size of the imaging device and suppressing the increase of power consumption of a sensor without performing complicated processing even if there are regions different in luminance mutually in an imaging plane. Furthermore, since the gains of the amplifiers can be uniformly set every frame by the present exemplary embodiment, a good image can be obtained by simple control.

### Third Exemplary Embodiment

A third exemplary embodiment according to the present invention is described with reference to FIGS. 7 and 9-13. In the present exemplary embodiment, the case of performing not only the control of the gains of the amplifiers in the imaging plane as illustrated in FIG. 7 but also the control of charge accumulating time is discussed. The frames F1, F2, and F3 are repeated also in the present exemplary embodiment similarly to the second exemplary embodiment.

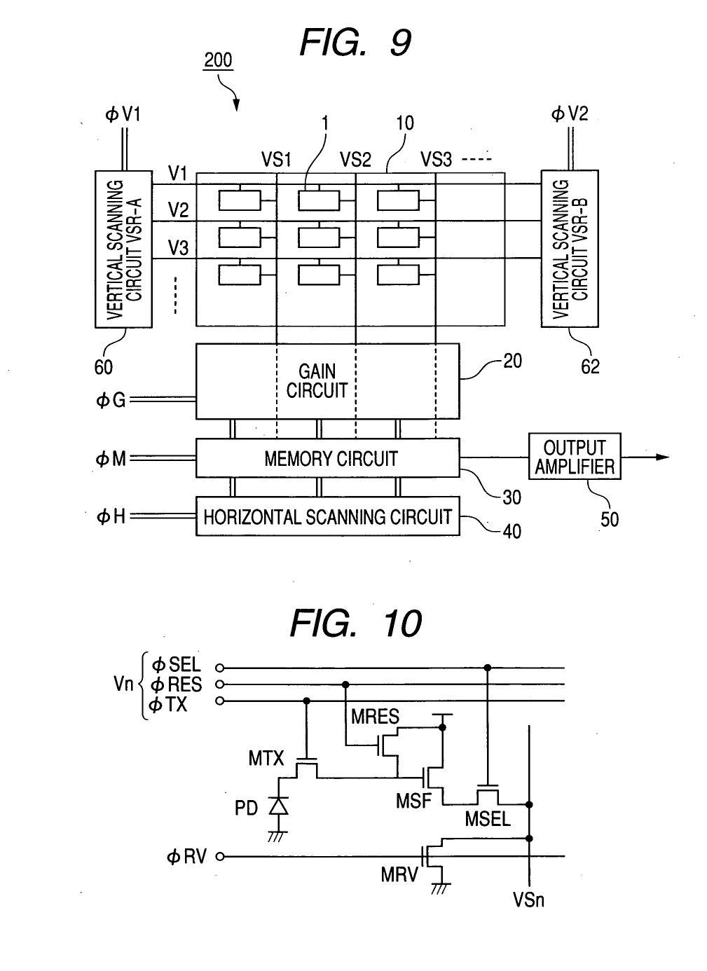

FIG. 9 is a schematic view illustrating an example of a solid-state imaging device according to the present exemplary embodiment, and the same components as those illustrated in FIG. 1 are denoted by the same reference numerals as those in FIG. 1. The solid-state imaging device of the present exemplary embodiment is different from that illustrated in FIG. 1 in being provided with a vertical scanning circuit 61 (VSR-B), which is a charge accumulation control unit controlled by a signal φV2, in addition to the vertical scanning circuit 60 (VSR-A) controlled by the signal φV1. Similarly to FIG. 1, the configuration illustrated in FIG. 9 is formed on the same semiconductor substrate.

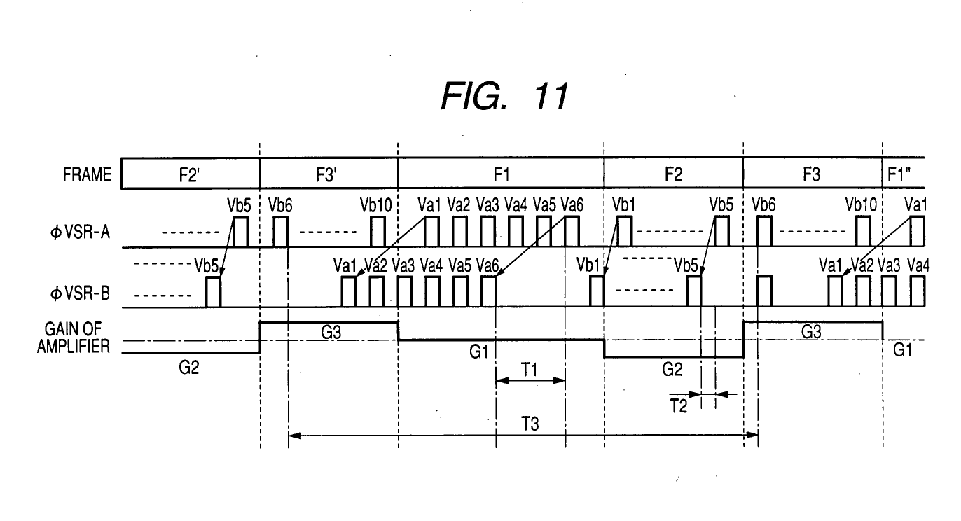

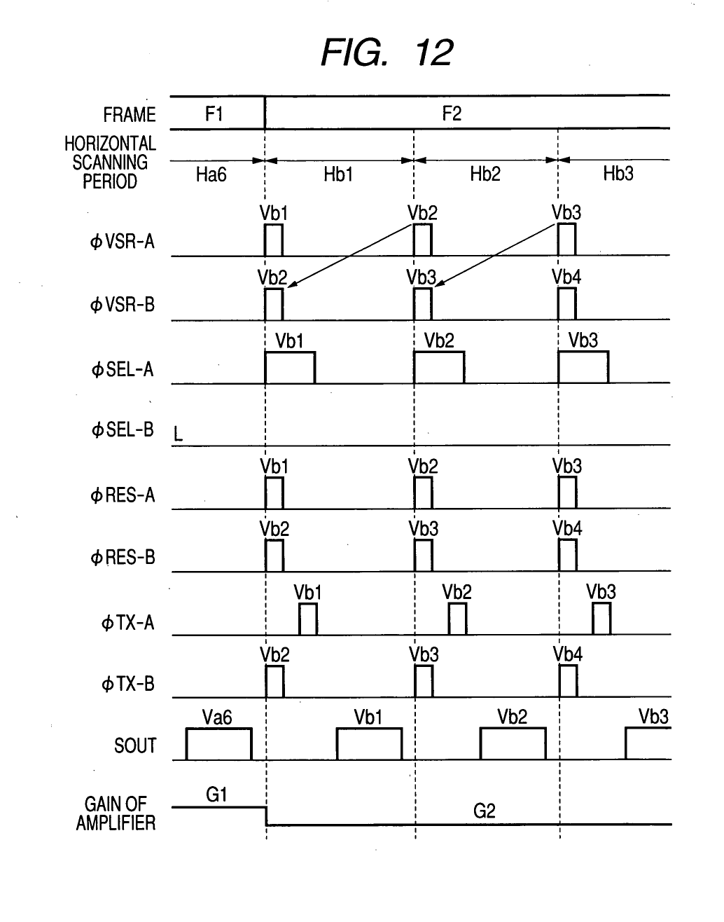

The vertical scanning circuit VSR-A internally generates a scanning signal φVSR-A (see FIGS. 11 and 12) according to the control signal φV1. Then, the vertical scanning circuit VSR-A generates a reset signal φRES-A, a transfer signal φTX-A, and a selection signal φSEL-A (see FIG. 12) according to the scanning signal φVSR-A, and sequentially supplies the generated reset signal φRES-A, transfer signal φTX-A, and selection signal φSEL-A to the pixels in each row in the pixel portion 10 via the control lines V1, V2, V3, . . . Vn. For example, the vertical scanning circuit VSR-A supplies the selection signal φSEL-A to one row of the pixel portion 10 to select pixels by the row in the pixel portion 10. Then, the vertical scanning circuit VSR-A supplies the transfer signal φTX-A to the pixels in the row to read signals from the pixels. Moreover, the vertical scanning circuit VSR-A resets the pixels by the setting of reading the signals from the pixels. That is, the vertical scanning circuit VSR-A performs the reset of the pixels by executing the read of the signals of the respective pixels in the pixel portion 10, and thereby completes their charge accumulating operations. The vertical scanning circuit VSR-A is, for example, a vertical scanning circuit.

For example, as illustrated in FIG. 7, the vertical scanning circuit VSR-A sequentially scans the pixel rows Va1, Va2, . . . , Va6 in the whole region W of the pixel portion 10 in the frame F1. The vertical scanning circuit VSR-A skips the rows except the pixel rows Va1, Va2, . . . , Va6 from the whole region W here.

Moreover, the vertical scanning circuit VSR-A selects the pixel rows Vb1-Vb5 from the partial region A in the frame F2, and selects the pixel rows Vb6-Vb10 from the partial region B in the frame F3.

The vertical scanning circuit VSR-B, which is a charge accumulation control unit, internally generates a scanning signal φVSR-B (see FIGS. 11 and 12) according to the control signal φV2. Then, the vertical scanning circuit VSR-B sequentially supplies a reset signal φRES-B, a transfer signal φTX-B, and a selection signal φSEL-B (see FIG. 12) to the pixels in each row in the pixel portion 10 via the control lines V1, V2, V3, . . . , Vn according to the scanning signal φVSR-B. For example, the vertical scanning circuit VSR-B supplies the reset signal φRES-B and the transfer signal φTX-B to pixels to perform the reset of the pixels. Then, the vertical scanning circuit VSR-B releases the reset of each of the pixels in the pixel portion 10, and thereby starts their charge accumulating operations.

The timing at which the vertical scanning circuit VSR-B makes the pixels start the charge accumulating operations and the timing at which the vertical scanning circuit VSR-A makes the pixels terminate the charge accumulating operations are different from each other. The vertical scanning circuit VSR-B performs the reset of the pixels in predetermined rows precedently to the completion of the charge accumulating operations by the vertical scanning circuit VSR-A, and starts the charge accumulating operations by releasing the reset. After that, the vertical scanning circuit VSR-A reads the signals in the rows to complete the charge accumulating operations. That is, by adjusting the timing of the vertical scanning circuit VSR-B to release the reset of the pixels and the timing of the vertical scanning circuit VSR-A to read the signals from the pixels, the charge accumulating time of the pixels in the pixel rows can be changed.

In the first and second exemplary embodiments, the charge accumulating time of the pixels in each row is the time from being read by the vertical scanning circuit VSR-A in a certain frame to being read in the frame to be read next. On the other hand, the present exemplary embodiment enables the adjustment of the charge accumulating time by being furthermore provided with the vertical scanning circuit VSR-B.

FIG. 10 illustrates a configuration example of a pixel 1 capable of realizing the aforesaid operations. The unit pixel exemplified in FIG. 10 includes a photodiode PD, a transfer switch MTX, a pixel amplifier MSF, a reset switch MRES, and a selection switch MSEL. A read of a signal from the unit pixel is performed by using a source follower formed by the pixel amplifier MSF and a constant current source MRV in a period in which the selection switch MSEL is conducting. The transfer switch MTX, the pixel amplifier MSF, the reset switch MRES, the selection switch MSEL, and the constant current source MRV are severally made of, for example, a metal oxide semiconductor (MOS) transistor. The photodiode PD performs a photoelectric conversion according to an incident light, and accumulates generated charges. The cathode of the photodiode PD is connected to the control electrode of the pixel amplifier MSF through the transfer switch MTX. The control electrode of the pixel amplifier MSF is connected to the power source and the drain of the pixel amplifier MSF itself through the reset switch MRES. The source electrode of the pixel amplifier MSF is connected to the vertical signal line VSn through the selection switch MSEL, and can form a source follower with the constant current source MRV provided on the vertical signal line VSn. The transfer switch MTX, the reset switch MRES, and the selection switch MSEL are controlled by signals φTX (including the signals φTX-A and φTX-B), φRES (including the signals φRES-A and φRES-B), and φSEL (including the signals φSEL-A and φSEL-B), respectively, transmitted from the vertical scanning circuits VSR-A and VSR-B through the control line Vn. As described above, the control line Vn is illustrated as one wire for simplification in FIG. 9, and the control line Vn includes the wires for transmitting the signals φTX, φRES, and φSEL in FIG. 10.

The timing of the operation of the present exemplary embodiment is more minutely described. FIG. 11 illustrates the frames F1-F3 and the frames existing before and after the frames F1-F3 in accordance with the time plotted on the abscissa axis at the uppermost stage of FIG. 11.

First, if the frame F1 is watched, since the pixels in the pixel rows read in the frame F1 are ones in the region the pixels in which severally have the average luminance, the gains of the amplifiers are set to the gain G1. Furthermore, because the pixels in the corresponding rows are reset by the generation of the signal φVSR-B before the read of the pixels by the generation of the signal φVSR-A in the frame F1, the charge accumulating time is shortened.

Moreover, because the pixels read in the frame F2 correspond to the high luminance partial region A, the gains of the amplifiers are set to the gain G2 lower than the gain G1, and the reset of the pixels by the signal φVSR-B is performed. The periods of the reset of the pixels in the high luminance partial region A by the signal φVSR-B and the read of the pixels by the signal φVSR-A are set to be shorter than those to the whole region W.

Moreover, since the pixels read in the frame F3 correspond to the low luminance partial region B, the gains of the amplifiers are set to the gain G3 higher than the gain G1. Since the reset by the signal φVSR-B to the pixels read in the frame F3 is not performed, a period T3 from the read in the frame F3′ to the read in the frame F3 is the charge accumulating time.

For example, the charge accumulating time according to the luminance of the regions from which signals are read can be set in accordance with the setting of the programs stored in the system control circuit 75 as the pieces of charge accumulating time T1-T3 of the pixels from which signals are red in the frames F1-F3 because the timing at which the signal φVSR-B is generated can be arbitrarily changed.

A timing example of the further concrete operation of the reset performed precedently to the read by the generation of the signal φVSR-B is described with reference to FIG. 12. The reset of the pixels in the pixel row Vb2 read in the frame F2 is performed by the generation of the signal φVSR-B by the vertical scanning circuit VSR-B in a horizontal scanning period Hb1 of the frame F2. The vertical scanning circuit VSR-A first generates the signal φVSR-A corresponding to the row Vb1 in the horizontal scanning period Hb1, and the vertical scanning circuit VSR-B simultaneously generates the signal φVSR-B corresponding to the row Vb2 here. In response to the generation of the signal φVSR-B, the vertical scanning circuit VSR-A inputs the signals φSEL-A and φRES-A to the row Vb1, and the vertical scanning circuit VSR-B inputs the signals φRES-B and φTX-B to the row Vb2. As a result, in each of the pixels in the row Vb1, the selection switch MSEL conducts; the pixel amplifier MSF and the constant current source MRV form a source follower; and the control electrode of the pixel amplifier MSF is reset. For example, if the solid-state imaging device includes a noise removal unit, such as a correlated double sampling (CDS) circuit, the sampling of the noise removal unit is performed after a change of the signal φRES-A to the low level. On the other hand, since the vertical scanning circuit VSR-B inputs the signals φRES-A and φTX-B into the row Vb2, in each of the pixels in the row Vb2, the reset switch MRES and the transfer switch MTX conduct; the charges accumulated in the photodiode PD and the charges held in the control electrode of the pixel amplifier MSF are ejected to the power source terminal; and then the pixel is reset.

Next, the input of the signal φTX-A from the vertical scanning circuit VSR-A into the pixels in the row Vb1 causes the transfer of the charges accumulated in each of the photodiodes PD to each of the control electrodes of the pixel amplifiers MSF. At this time, since the selection switches MSEL conduct, the source followers are formed, and the electric potential on the vertical signal line VSn becomes that corresponding to the electric potential of the control electrodes of the pixel amplifiers MSF. The electric potential of the vertical signal line VSn after the change of the electric potential is stored in the memory circuit 30.

At the same time as the transition of the signal φTX-A to the low level, the signal φSEL-A also transits to the low level, and the source followers each formed of the pixel amplifier MSF and the constant current source MRV of each of the pixels in the row Vb1 are released.

Next, the horizontal scanning circuit 40 scans the memory circuit 30 to output the held signals from the output amplifier 50 to the outside of the solid-state imaging device 200 during a period SOUT.

Similar operations are performed in the horizontal scanning periods Hb2, Hb3, . . . succeeding to the horizontal scanning period Hb1, and the signals in the rows Vb2, Vb3, . . . are sequentially output.

By controlling the charge accumulation time in each of the image regions A, B, and C in addition to the gains of the amplifiers like the present exemplary embodiment, finer control can be performed in comparison with the case of controlling only the gains of the amplifiers, and it can be performed to widen the range of the luminance in which images can be recognized. Incidentally, although the signals φVSR-A and φVSR-B are simultaneously changed in FIG. 12, the drive pattern is not limited to such one.

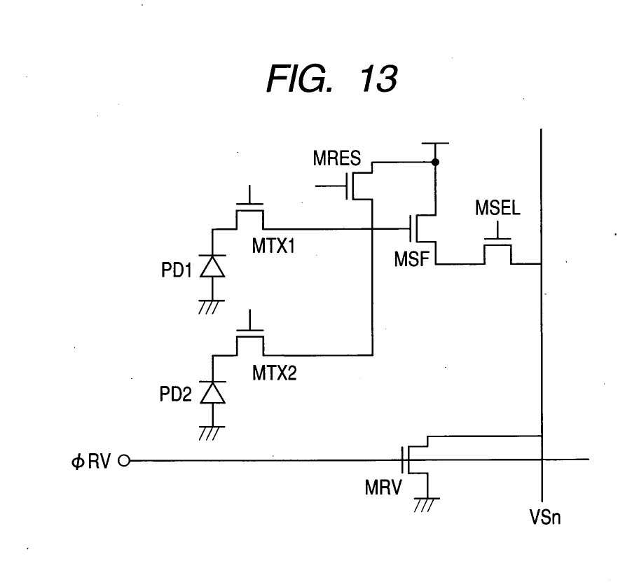

Moreover, another configuration example of a pixel to which the operation of the present exemplary embodiment can be applied is illustrated in FIG. 13. The configuration example is one in which two photodiodes PD1 and PD2 and two transfer switches MTX1 and MTX2 share a reset switch MRES, a pixel amplifier MSF, and a selection switch MSEL, and is effective for the space saving of the pixel portion. For example, if the photodiodes PD1 and PD2 are arranged over two rows, it is conceivable to treat the photodiodes PD1 and PD2 as the pixels in first and second rows, respectively.

Moreover, as the scanning of reading the signals in the partial regions A and B, the rows Vb1-Vb10 may be selected by single scanning, or the rows Vb1-Vb5 and the rows Vb6-Vb10 may be selected by different scanning. The term of frame is considered by the image displayed by the reproducing system & displaying system 76 here. Consequently, the partial regions A and B are considered as different frames in both of the cases of the single scanning and the different scanning.

According to the present exemplary embodiment described above, a good image suppressing the reduction of the SN ratio thereof can be obtained, suppressing the increase of the chip size of the imaging device and suppressing the increase of power consumption of a sensor without performing complicated processing even if there are regions different in luminance mutually in an imaging plane. Furthermore, by controlling the charge accumulating time, the range of the luminance in which images can be recognized can be widened.

The exemplary embodiments described above are only intended to be exemplified, and the scope of the present invention is not limited by the exemplary embodiments. For example, although the positions of the high luminance region A and the low luminance region B are fixed in an imaging plane, the present invention can be applied even if these regions A and B move between frames. Moreover, two partial regions A and B severally exist in both of the first and second exemplary embodiments, but the number of the partial regions A and B may be one. Alternatively, even if three or more partial regions exist, the present invention can be applied.

Moreover, as an application example of the present invention, a monitoring camera is conceivable. The monitoring camera generally includes a wide range of luminance in an imaging plane occasionally, and good images can be obtained even in the regions where luminance is remarkably high or low in an imaging plane by applying the present invention to the monitoring camera. At this time, if the ratio of the number of pixels of the first pixel group to the number of pixels of the whole imaging plane, that is, the density of the first pixel group (first density) is made to be lower than the ratio of the number of the pixels of the second pixel group to the number of the pixels of the corresponding partial regions, that is, the density of the second pixel group (second densities), then only the specific region in the second pixel group that a user wants to watch can be obtained at high resolution while monitoring the whole imaging plane. Then, by differentiating gains between those in the regions of the first and second pixel groups, a good image can be obtained even if the luminance of the watching region in the second pixel group is remarkably different from that in the other regions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-290733, filed Nov. 8, 2007, which is hereby incorporated by reference herein in its entirety.

1. A solid-state imaging device comprising:
a pixel portion including pixels arranged along rows and columns; and
a plurality of variable gain units corresponding to the columns of the pixel portion, wherein
the variable gain units amplify signals from first and second pixel groups each including a plurality of pixels of the pixel portion, in different gains for each of the groups of the pixels, responsive to a gain control signal inputted from an external.

2. The solid-state imaging device according to claim 1, wherein the pixel portion and the variable gain unit are formed on the same semiconductor substrate.

3. The solid-state imaging device according to claim 1, further comprising
a charge accumulation control unit for resetting the pixel based on the signal inputted from the external, to control a start of the charge accumulation of the pixel.

4. The solid-state imaging device according to claim 3, wherein the charge accumulation control unit is formed on the same semiconductor substrate as one on which the pixel portion and the variable gain unit are placed.

5. The solid-state imaging device according to claim 1, wherein the solid-state imaging device is incorporated in an imaging system that includes:
an output unit for externally outputting a signal amplified by the variable gain unit; and
a control unit for supplying the gain control signal to the plurality of variable gain units.

6. The solid-state imaging device according to claim 3, wherein the solid-state imaging device is incorporated in an imaging system that includes:
an output unit for externally outputting a signal amplified by the variable gain unit; and
a control unit for supplying the gain control signal to the plurality of variable gain units, wherein the control unit inputs a signal into the charge accumulation control unit, and the imaging system begins the charge accumulation of the pixel based on the signal inputted.

7. The solid-state imaging device according to claim 5, wherein the control unit outputs the signal of the pixel of first pixel group and the signal of the pixel of second pixel group, in different frames, from the output unit.

8. The solid-state imaging device according to claim 5,
wherein, when the pixels are scanned one row by one row, and the row scanned includes the pixels of the first and second group, and
wherein the control unit supplies the gain control signal to the variable gain unit to change the gain during a time period, after outputting from the output unit the signal of the pixel of the one of the first and second groups, and before outputting from the output unit the signal of the pixel of the other of the first and second groups.

9. The solid-state imaging device according to claim 5, wherein the imaging system further includes a processing unit for outputting a luminance signal according to an average luminance of each of the pixels of the first and second pixel groups, wherein the processing unit supplies a gain control signal to the variable gain unit according to the luminance signal.

10. The solid-state imaging device according to claim 6, wherein the control unit supplies a signal to the charge accumulation control unit to reset the pixel, during a time period after outputting the signal of the pixel from the outputting unit and before outputting the signal of the same pixel from the outputting unit.

11. The solid-state imaging device according to claim 5,
wherein the first pixel groups correspond to whole of the pixel portion, and signal outputting pixels among the pixels included in the first pixel groups are arranged in a first density, and
wherein the second pixel groups correspond to a part of the pixel portion, and signal outputting pixels among the pixels included in the second pixel groups are arranged in a second density.

12. A method of driving a solid-state imaging device that includes a pixel portion with pixels arranged along rows and columns, and a plurality of variable gain units corresponding to the columns of the pixel portion, the method comprising:
controlling the variable gain units to amplify signals from first and second pixel groups each including the plurality of pixels of the pixel portion, in a different gains for each of the groups of the pixels.
